(19) United States
(12) Patent Application Publication
(10) Pub. No.: US 2011/0109416 A1
(43) Pub. Date: May 12, 2011

(54) INDUCTOR OF CIRCUIT BOARD

(75) Inventors: CHENG-LIANG HSIAO, Miao-Li County (TW); JIE CHEN, Shenzhen City (CN)

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/944,778

(22) Filed: Nov. 12, 2010

(30) Foreign Application Priority Data
Nov. 12, 2009 (CN) 200910309610.9

(51) Int. Cl. H01F 5/00

(52) U.S. Cl. 336/200

(57) ABSTRACT

An exemplary inductor of a circuit board includes a base portion of the circuit board, a plurality of through holes defined in two opposite sides of the base portion and a conductive wiring passing through the through holes and wrapping the base portion. The inductor arranged in the circuit board allows height of the printed circuit board to be minimized.

### BACKGROUND

1. Technical Field

The present disclosure relates to a circuit board with an inductor formed thereon.

2. Description of Related Art

A circuit board such as a printed circuit board (PCB) often includes a number of electronic components, such as inductors, capacitors, resistors, chips and others, welded thereon. An independent inductor can be applied to a PCB. The PCB includes several pins welded thereon at high temperature to fix and connect with the inductor. Wire-wound coils of the inductor are connected to each other end to end and form a helical shape. In general, a maximum thickness of the PCB is 0.4 mm (millimeters), and a maximum height of the inductor is 1.5 mm. This means the PCB cannot achieve a high degree of thinness due to the height of the welded inductor. Thus the PCB cannot be used in certain miniaturized applications.

What is needed, therefore, is an inductor arranged with a printed circuit board, wherein the arrangement can overcome the described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a perspective front view of a printed circuit board with an inductor arranged thereon according to an exemplary first embodiment of the present disclosure.

FIG. 2 is a perspective front view of a printed circuit board with an inductor arranged thereon according to an exemplary second embodiment of the present disclosure.

FIG. 3 is an enlarged cross-section taken along a line III-III of FIG. 2.

FIG. 4 is a perspective front view of a printed circuit board with an inductor arranged thereon according to an exemplary third embodiment of the present disclosure.

FIG. 5 is a perspective front view of a printed circuit board with an inductor arranged thereon according to an exemplary fourth embodiment of the present disclosure.

FIG. 6 is a perspective front view of a printed circuit board with an inductor arranged thereon according to an exemplary fifth embodiment of the present disclosure.

### DETAILED DESCRIPTION

Reference will now be made to the drawings to describe certain exemplary embodiments in detail.

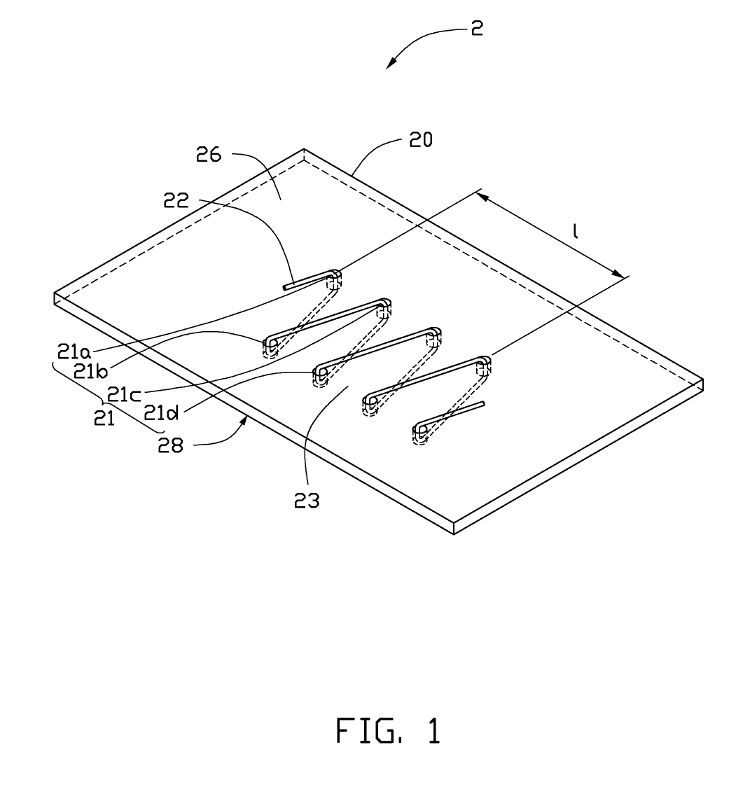

Referring to FIG. 1, a first embodiment of a printed circuit board (PCB) 2 with at least one inductor arranged thereon is shown. For simplicity, only one inductor is illustrated in FIG. 1; and in the following description, unless the context indicates otherwise, only one inductor is described. The PCB 2 includes a body 20. The body 20 includes a top surface 26, a bottom surface 28, and a central base portion 23. The base portion 23 defines a plurality of through holes 21 therein. The through holes 21 pass through the base portion 23 from the top surface 26 to the bottom surface 28. The through holes 21 are located at peak or valley points of a saw tooth shape, respectively. A conductive wiring 22 passes through the through holes 21 and runs along a track of the saw tooth shape, thereby surrounding the base portion 23. In one aspect, the conductive wiring 22 can be considered to be laced on the base portion 23 via the through holes 21. The conductive wiring 22 and the through holes 21 and the base portion 23 form at least one inductor. Two opposite ends (not labeled) of the conductive wiring 22 are respectively electrically connected to an external circuit (such as a power supply) for receiving voltage applied by the external circuit. The two ends thereby form two terminals of the inductor.

In the first embodiment, the through holes 21 are evenly arrayed in two parallel lines. In each of the two lines, a distance between each two adjacent through holes 21 is the same. In addition, the pitch of the through holes 21 in a first one of the lines is the same as the pitch of the through holes 21 in the second line. Preferably, the through holes 21 in the first line are regularly staggered relative to the through holes 21 in the second line. That is, for example, a first through hole 21b of the second line is in a staggered position midway between a first through hole 21a of the first line and a second through hole 21c of the first line. The conductive wiring 22 passes through the first through holes 21a, 21b and the second through holes 21c, 21d in that order. The conductive wiring 22 wraps the base portion 23 of the PCB 2 and presents a generally helical shape, forming the inductor.

An inductance value L of the inductor generally follows the formula:

L=(k×μ0×μs×N²×S)/l

For the purposes of the formula, one winding of the least one inductor of the PCB 2 is defined by the conductive wiring 22 running from the top surface 26 to the bottom surface 28 and back again in a generally zigzag pattern as shown. For example, one winding is defined between the conductive wiring 22 at the top of first through hole 21a and the conductive wiring 22 at the top of second through hole 21c. In the formula, l denotes an axial length of the windings formed by the conductive wiring 22, N denotes the number of windings, and k is a coefficient denoting or corresponding to a ratio of the radius (R) and the length (l) of the winding. μ0 denotes the permeability of free space, being 4π×10⁻⁷. μs denotes a relative permeability of the winding. For example, when the winding is empty, μs=1. S denotes a transverse cross-sectional area of the winding. The unit of S is m² (square meters). The unit of l is m (meters). The unit of the calculated inductance is henry.

According to the formula, by adjusting any one or more of N, l, and S, one can achieve different desired inductance values L.

By providing the through holes 21 in the PCB 2, the conductive wiring 22 can pass through the through holes 21 between the top surface 26 and the bottom surface 28 to wrap the base portion 23 and form the inductor. There is no need to set individual standard inductors on the PCB 2, and thus the PCB 2 has a minimized profile (height or thickness).

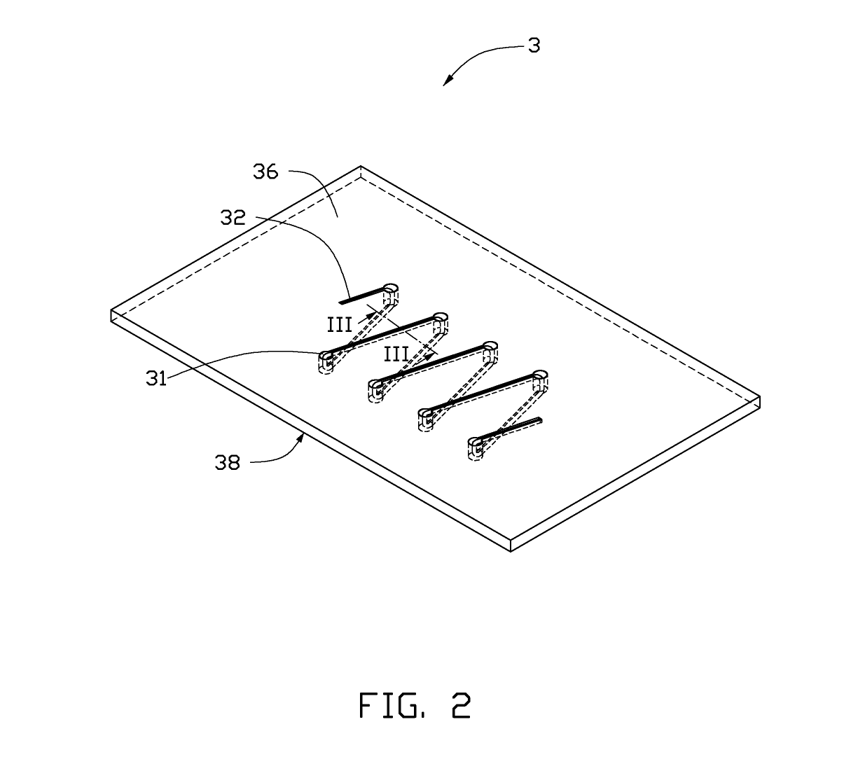

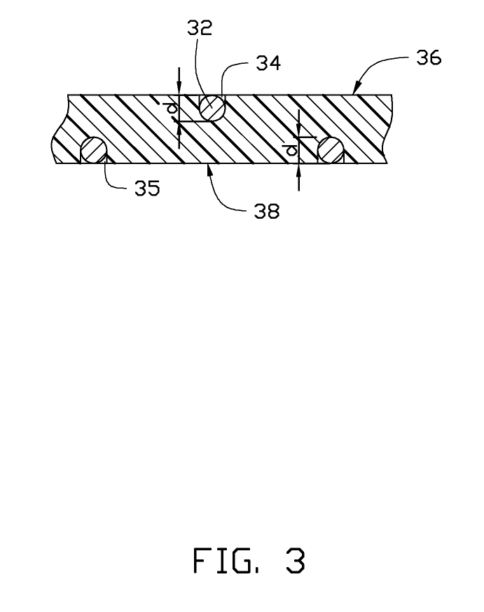

Referring to FIGS. 2 and 3, a second embodiment of a printed circuit board 3 with an inductor arranged thereon is shown. The PCB 3 differs from the PCB 2 of the first embodiment only in that a conductive wiring 32 passes through a plurality of grooves 34 and 35 as well as through a plurality of through holes 31. The grooves 34 and 35 are defined in top and bottom surfaces 36 and 38 of the PCB 3, respectively, and respectively correspond to straight sections (not labeled) of the conductive wiring 32. A depth d of the grooves 34, 35 is substantially equal to a diameter of the conductive wiring 32. The number of sections of the conductive wiring 32 is in the same as the number of grooves 34, 35 of the PCB 3. Thus the conductive wiring 32 is arranged along a track of a saw tooth shape. With the above-described configuration, the overall thickness of the PCB 3 is minimized.

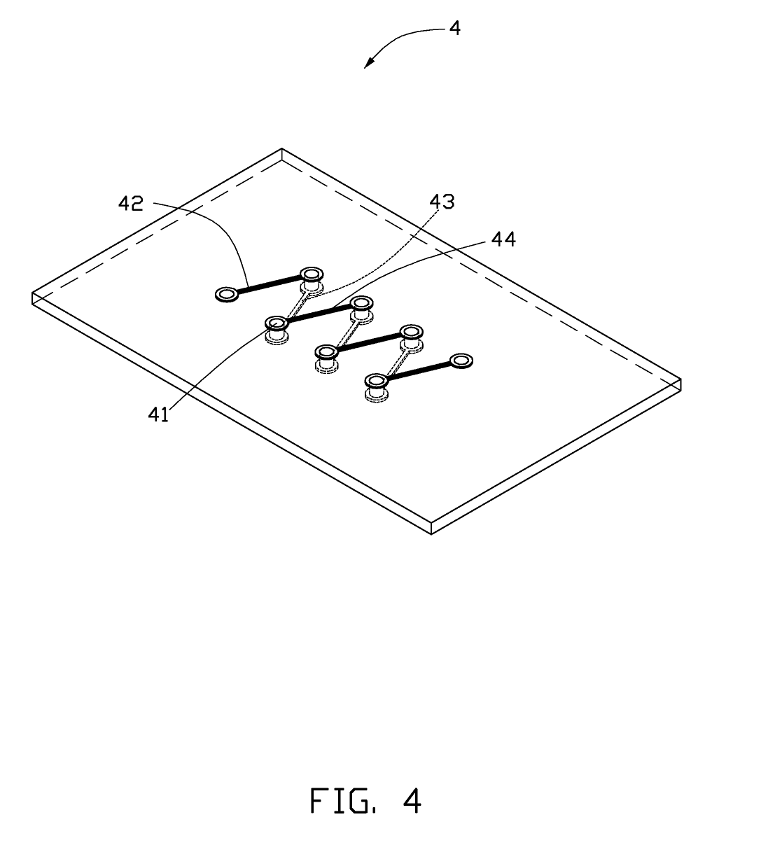

Referring to FIG. 4, a third embodiment of a printed circuit board 4 with an inductor arranged thereon is shown The PCB 4 differs from the PCB 2 of the first embodiment only in that a number of conductors 41 essentially replace the through holes 21. In particular, each of through holes (not labeled) of the PCB 4 includes one conductor 41 accommodated therein. In the illustrated embodiment, the conductor 41 is essentially a solid cylinder with enlarged top and bottom ends. Each of the enlarged top and bottom ends is in the form of a ring surrounding and connecting the top or bottom of the conductor 41, respectively. The enlarged top end abuts a top surface of the PCB 4 which forms a top rim around a top of the through hole. The enlarged bottom end abuts a bottom surface of the PCB 4 which forms a bottom rim around a bottom of the through hole. The conductive wiring (not labeled) includes a plurality of sections, such as sections 42, 43, 44. Ends of the sections 42, 43, 44 are electrically connected to peripheries of corresponding enlarged ends of the respective conductors 41. Thus the sections 42, 43, 44 are arranged along the track of a saw tooth shape. All the sections including the sections 42, 43, 44 together with all the conductors 41 cooperatively present a generally helical shape, forming the inductor.

In other embodiments related to the third embodiment, the conductors 41 can be essentially hollow cylinders with enlarged top and bottom ends. In still other embodiments, the enlarged ends of each conductor 41 can be integrally formed with the top and bottom of the conductor 41. That is, the entire conductor 41 including the enlarged ends is a single monolithic body of the one same material. In yet other embodiments, the PCB 4 can have grooves much like the grooves 34, 35 of the PCB 3 of the second embodiment, and the enlarged top and bottom ends of the conductors 41 can be embedded in the top and bottom surfaces of the PCB 4.

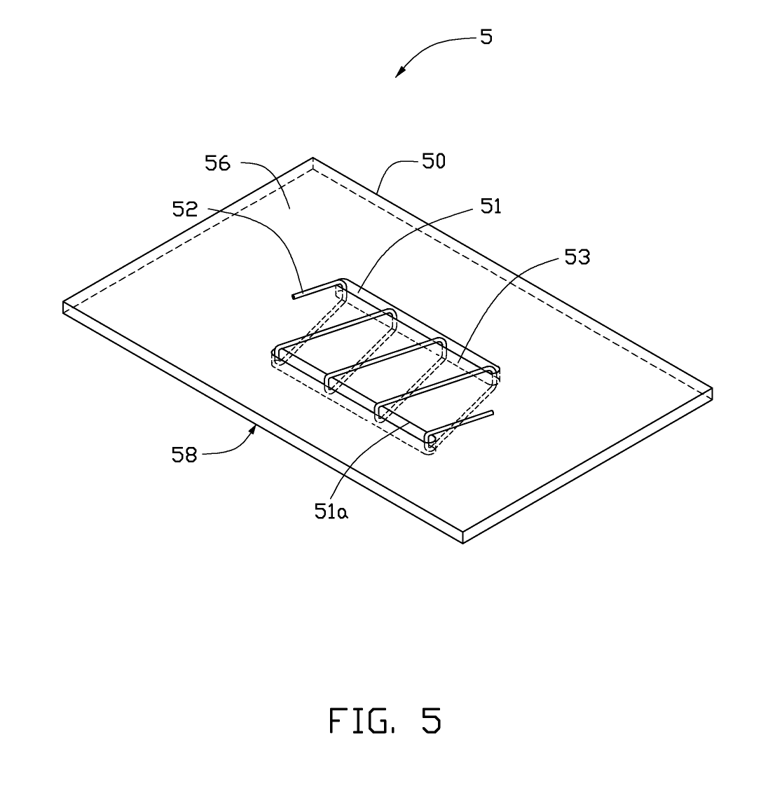

Referring to FIG. 5, a fourth embodiment of a printed circuit board 5 with an inductor arranged thereon is shown. In this embodiment, a body 50 of the PCB 5 includes a top surface 56, a bottom surface 58, and a central base portion 53. The base portion 53 defines two parallel through holes 51, 51a passing through the body 50. That is, the through holes 51, 51a are in the form of through slots. A conductive wiring 52 is wound round the base portion 53 by passing through the two parallel through holes 51, 51a again and again. Thereby, the conductive wiring 52 presents a generally helical shape, forming the inductor.

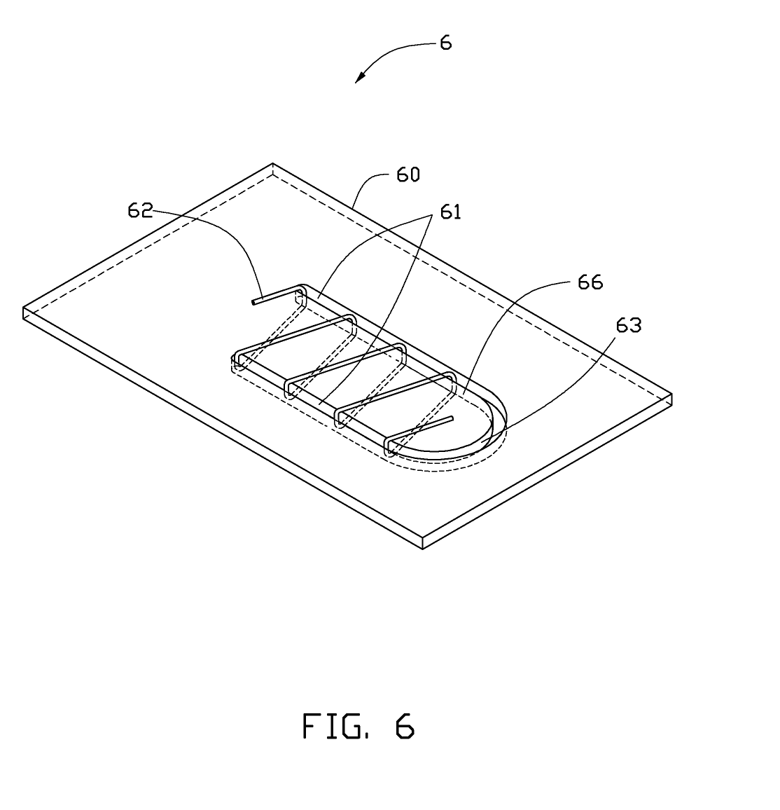

Referring to FIG. 6, a fifth embodiment of a printed circuit board 6 with an inductor arranged thereon is shown. In this embodiment, a semicircular connecting through hole 63 is defined in a body 60 of the PCB 6, and intercommunicates two parallel through holes 61 defined in the body 60. That is, the connecting through hole 63 and the through holes 61 are in the form of through slots. Thus the two through holes 61 and the connecting through hole 63 cooperatively form a single U-shaped through hole (through slot). The U-shaped through hole is bounded on one side by a U-shaped inner wall 66 of the PCB 6. A conductive wiring 62 wraps the inner wall 66 to present a generally helical shape, forming the inductor.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of shape, size and arrangement of parts within the principles of the disclosure to the full extent indicated by the broad general meaning of the terms in which the appended claims are expressed. In particular, even though the exemplary embodiments are printed circuit boards, the scope of this disclosure covers circuit boards in general.

What is claimed is:

1. An inductor of a circuit board, the inductor comprising:
a base portion of the circuit board, a plurality of through holes defined in two opposite sides of the base portion; and
a conductive wiring passing through the through holes and wrapping the base portion.

2. The inductor of claim 1, wherein the through holes are located at peak and valley points of a saw tooth shape defined by the conductive wiring.

3. The inductor of claim 2, further comprising a plurality of grooves defined in a top and a bottom surfaces of the base portion, wherein each of the grooves communicates with two corresponding through holes along the track of the saw tooth shape.

4. The inductor of claim 3, wherein a depth of each of the grooves is substantially equal to a diameter of the conductive wiring.

5. The inductor of claim 2, further comprising a plurality of conductors received in the through holes, respectively, wherein the conductive wiring comprises a plurality of sections, and each of the sections is electrically connected to two corresponding sequential conductors along the track of the saw tooth shape.

6. The inductor of claim 5, wherein each of the conductors is essentially a solid cylinder with enlarged top and bottom ends, and each of the enlarged top and bottom ends is in the form of a ring surrounding and connecting the top or bottom of the conductor, respectively.

7. The inductor of claim 5, wherein each of the conductors is essentially a hollow cylinder with enlarged top and bottom ends, and each of the enlarged top and bottom ends is in the form of a ring surrounding and connecting the top or bottom of the conductor, respectively.

8. The inductor of claim 5, further comprising a plurality of grooves defined in a top and a bottom surfaces of the base portion, wherein each of the grooves spans between two corresponding conductors along the track of the saw tooth shape, and the enlarged top and bottom ends are embedded in the top and bottom surfaces of the base portion, respectively.

9. The inductor of claim 8, wherein a depth of each of the grooves is substantially equal to a diameter of the conductive wiring.

10. The inductor of claim 5, wherein the through holes comprises a first line of through holes and a second line of through holes, which are arranged at peak and valley points of the saw tooth shape, respectively.

11. The inductor of claim 10, wherein the first line of through holes and the second line of through holes are parallel to each other.

12. The inductor of claim 11, wherein in each of the two lines of through holes, a distance between each two adjacent through holes is the same.

13. The inductor of claim 11, wherein the first line of through holes is staggered relative to the second line of through holes.

14. The inductor of claim 1, wherein two opposite ends of the conductive wiring serve as two terminals of the inductor, for electrical connection to an external voltage.

15. A circuit board comprising:
a body defining a top surface and a bottom surface; and
an inductor formed on the body, the inductor comprising:
a central base portion of the body;
a plurality of through holes defined in two opposite sides of the base portion; and
a conductive wiring passing through the through holes and wrapping the base portion.

16. The circuit board of claim 15, wherein the through holes are a pair of parallel slots.

17. The circuit board of claim 16, wherein the inductor further comprises a connecting through slot, the connecting through slot intercommunicating the two through slots.

18. The circuit board of claim 17, wherein the two through slots and the connecting through slot cooperatively form a single U-shaped through slot.

19. The circuit board of claim 15, wherein two opposite ends of the conductive wiring serve as two terminals of the inductor, for electrical connection to an external voltage.

20. On a circuit board, an inductor comprising:
at least two openings each defined through a thickness of a base portion of the circuit board, the at least two openings arranged in two parallel lines; and
a wiring wrapping the base portion of the circuit board by traversing through the at least two openings alternately from one line to the other line.
